(19) United States
(12) Patent Application Publication
(10) Pub. No.: US 2009/0093782 A1
(43) Pub. Date: Apr. 9, 2009

(54) Mask to compress face

(76) Inventor: Mady Attila, Kihei, HI (US)

Correspondence Address: Attila Mady, 105 Manino Circle, Suite 203, Kihei, HI, 96753, US

(21) Appl. No.: 11/868,221

(22) Filed: Oct. 5, 2007

(51) Int. Cl. A61H 33/00

(52) U.S. Cl. 604/303

(57) ABSTRACT

An inflatable mask to distribute pressure evenly and seamlessly across the face for the purpose of reducing edema, wrinkling and aging.

An inflatable mask to distribute pressure evenly and seamlessly across the face for the purpose of reducing edema, wrinkling and aging.

### TECHNICAL FIELD

Beauty products, personal health, personal hygiene.

### LEXICON

The face mask of claim 1 is defined as the entire container, though only the anterior aspect approximates against the facial skin.

### BACKGROUND OF THE INVENTION

Vanity will always remain a prominent human trait. It stems from the biological instinct to prevail and reproduce. It is augmented by man's structural instinct to avoid and fear death.

Endless strategies have been proposed to appease vanity. Some examples would be interventions to lose weight, increase height, change hair color, apply superficial disguise to female facial skin, inject pigments into human skin, perforate, slice and otherwise mutilate ears, nose, eyebrows, bones, limbs, female and male labia, apply precious metals and jewels in various configurations, as well as endless variations to enfold this questionably enhanced construct within various garments.

Enormous resources are expended on proposed remedies for aging. Some, such as remedies for diseases, hospital care for acute crises and hormone treatments for degenerative changes that occur with time, are highly effective. Cosmetic treatments usually are not.

Facial aging in particular is a prominent concern to those possessed of vanity. The face is prominently displayed to inspection and also prominently exposed to insults.

Considerable resources have been expended on trying to retard or reverse facial aging. Make-up, superficial chemicals, lasers, scalpels, injected chemicals, fillers, permanent pigments, subcutaneous implants, etc. have been used for this purpose.

This application does not concern itself with any such intervention, whether effective or not. This application exploits the observation that humans usually sleep in a horizontal position. The human face swells after a certain period in this horizontal position. Drainage of this fluid from the face during the day contributes to the “tired” look. Prevention of edema in the first place prevents this phenomenon and also the chronic changes that are induced by repeated episodes of facial swelling caused by any but the briefest periods of sleep.

It is further noted that people who swim on a regular basis tend to look younger than people who do not. Competitive swimmers are noted to preserve their appearance particularly well. The generally held belief is that this is because they are healthier and their body weight is less variable. A heretofore unrecognized factor may be that the water exerts considerable direct pressure on all body surfaces and therefore diminishes this phenomenon of diurnal edema cycle.

### SUMMARY OF THE INVENTION

An inflatable mask distributes pressure evenly and seamlessly across the face for the purpose of reducing edema, wrinkling and aging.

### DETAILED DESCRIPTION OF THE INVENTION

A double walled spherical or cranium shaped container constituting a face mask at the front and supporting extension posteriorly (the entirety of this apparatus heretofore termed the “mask”).

This mask is generally shaped like a head. It can be specifically shaped to a particular individual through the use of individually casted molds.

Alternatively, a limited number of cranial prototypes can be established and masks manufactured in groups to conform to each of these cranial types. Individual masks in this case would conform with variable accuracy to individual users.

This variably conforming mask has apertures conforming to the eyes, ears, mouth, nose and neck of wearer. At least the outer layer is made of a non-distensible or only slightly distensible material.

This variably conforming mask is pulled over the head and positioned for best fit. This involves approximating it against the cranium posteriorly and against the face anteriorly.

Alternatively the mask may be provided with a means (such as Velcro tape) of fastening and unfastening posteriorly. This would obviously provide more flexibility and ease of use, but may compromise slightly accuracy once applied, and therefore clinical utility.

The inner surface of the mask should be very smooth in order to distribute pressure evenly. Once positioned, the mask is inflated through the insertion of either air or water under pressure into the potential space defined by between the two layers of the mask through a one way valve apparatus.

Inflation of the mask results in the transmission of pressure to the face, which will in turn compress the facial skin and subcutaneous tissue.

By controlling the amount of pressure generating substance instilled the user has accurate control of the overall applied pressure.

When release is desired, the user opens the one way valve, or some other means of evacuating the pressure generating substance. Evacuation of this substance results in decrease of the mask to its pre-inflation dimensions. The face mask is then removed.

This face mask has been tried and it works.

### DISTINCTION FROM PRIOR ART

There are many patents regarding face masks for the purpose of anti-gas protection, as well as various sporting activities. They are not addressed here.

There are a number of cosmetic applications, but they generally prescribe application of a mask for a delivery of various treatments. None describe direct contact with the face throughout its surface, or for the purpose of compression. They are therefore not applicable.

### DESCRIPTION OF THE DRAWINGS

FIG. 1 (frontal view) illustrates the device as envisioned uninflated and undeployed. Individual items of interest are labeled on the diagram.

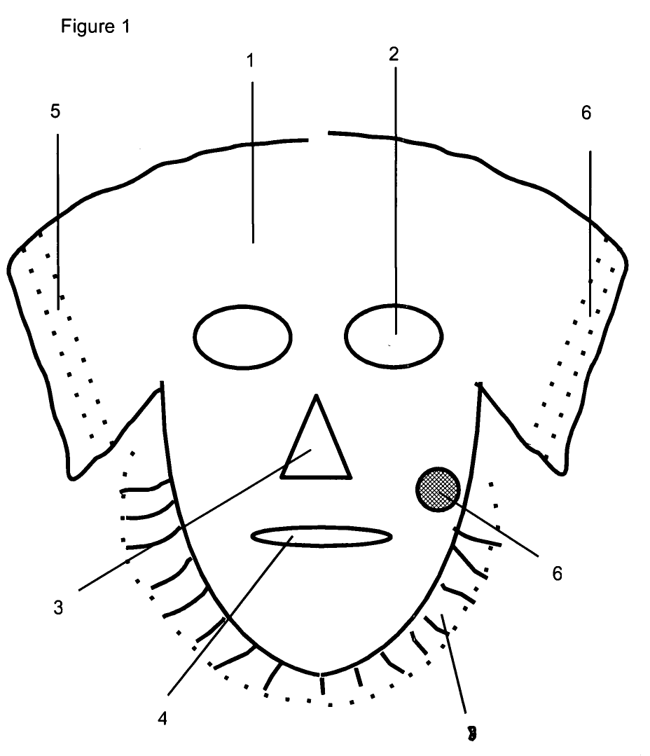

FIG. 2 (side rear view) illustrates the device uninflated and undeployed. Individual items of interest are labeled on the diagram.

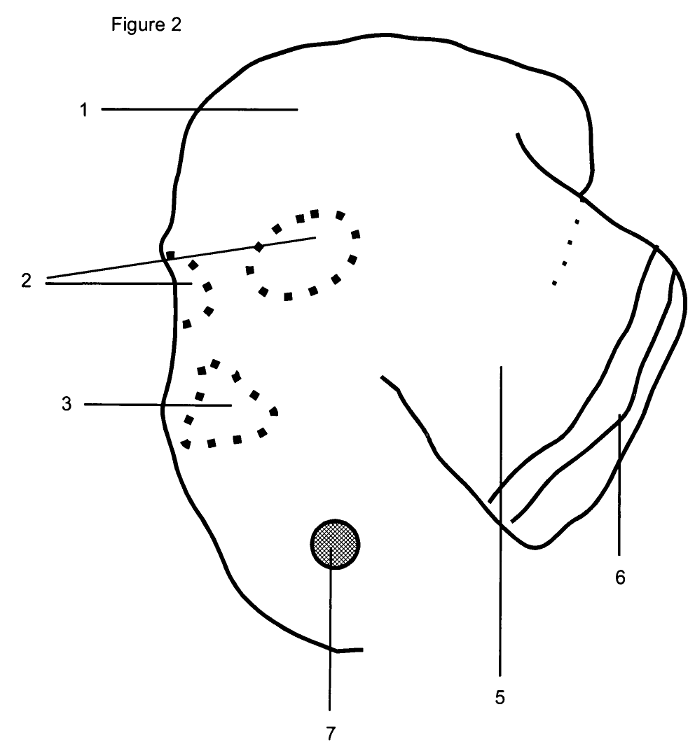

FIG. 3 (longitudinal cross section) illustrates the device as applied to a prototypical user. Individual items of interest are labeled on the diagram.

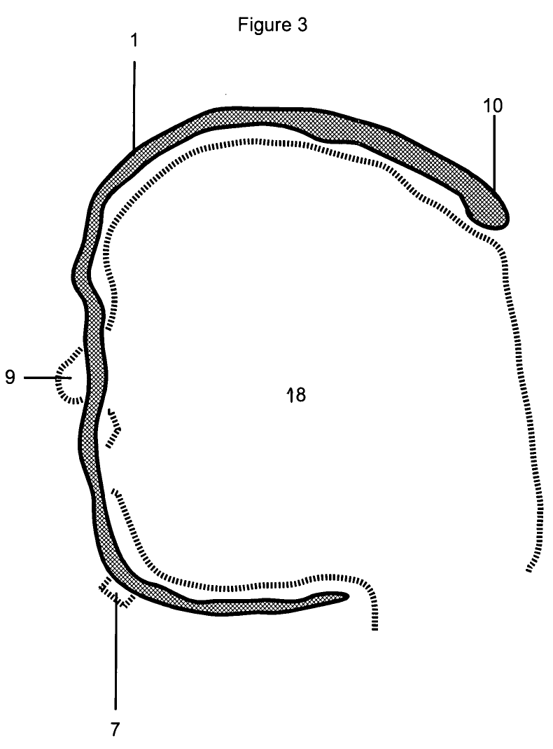

1: A spherical or cranium shaped double walled container constituting a face mask at the front with a supportive extension posteriorly

2: The double walled container of claim 1 with apertures conforming to the eyes, ears, mouth, nose and neck of wearer

3: At least the outer layer of the double walled container of claim 1 made of a non-distensible or only slightly distensible material

4: The double walled container of claim 1 to be approximated against the cranium and the face and capable of conforming somewhat to these shapes

5: The double walled container of claim 1 possibly provided with means of release and reassembly posteriorly

6: The inner surface of the double walled container of claim 1 to be made of a seamlessly smooth membrane designed to apply pressure evenly to facial skin and tissue

7: The means of incrementing pressure between the two layers of said double walled container of claim 1 through the introduction of a liquid or air through a one-way valvular apparatus

8: The means of releasing pressure from between the two layers of said double walled container of claim 1 through the evacuation of the liquid or air originally inserted between the two layers as described in claim 7
